(19) United States
(12) Patent Application Publication
(10) Pub. No.: US 2011/0084816 A1
(43) Pub. Date: Apr. 14, 2011

(54) APPARATUS AND METHOD FOR REDUCING THE CURRENT CONSUMPTION OF A CONTROL CIRCUIT

(76) Inventors: Stephanie Briese, Regensburg (DE); Ulrich Emmerling, Kelheim (DE); Daniel Hostmann, Regensburg (DE); Matthias Huschenbett, Regensburg (DE); Rupert Schuster, Rohrbach (DE); Roland Wagner, Kassel (DE)

(21) Appl. No.: 12/996,061

(22) PCT Filed: May 28, 2009
(86) PCT No.: PCT/EP2009/056549

§ 371 Date: Dec. 3, 2010

(30) Foreign Application Priority Data
Jun. 5, 2008 (DE) 10 2008 026 845.3

(51) Int. Cl. H04Q 5/22

(52) U.S. Cl. 340/10.34

(57) ABSTRACT

Through a microcontroller, control signals are transferred to a transmitting and receiving unit or configuration data are transferred. Through the transmitting and receiving unit, in a first operating state transmission signals are issued, while controlling the control signals of the microcontroller. Upon a first specified event, the transmitting and receiving unit is switched to a second operating state through a one-time transfer of corresponding configuration data by the microcontroller. In the second operating state, the transmitting and receiving unit automatically transmits repeated transmission signals. The microcontroller immediately switches to a current-saving or non-current, inactive operating state after said microcontroller has switched the transmitting and receiving unit to the second operating state. As a reaction to a second specific event, the transmitting and receiving unit switches to the first operating state and produces a state change signal for the microcontroller, which switches to the active operating state as a reaction thereto.

### CROSS-REFERENCE TO RELATED APPLICATIONS

This application is a U.S. National Stage Application of International Application No. PCT/EP2009/056549 filed May 28, 2009, which designates the United States of America, and claims priority to German Application No. 10 2008 026 845.3 filed Jun. 5, 2008, the contents of which are hereby incorporated by reference in their entirety.

### TECHNICAL FIELD

The invention relates to an apparatus and a method for reducing the current consumption of a control circuit and especially to an apparatus and method for reducing the current consumption when the apparatus is being operated in polling mode.

### BACKGROUND

In a plurality of vehicles, especially motor vehicles, a plurality of functions are already now triggered or controlled via mobile transmitting and receiving units carried by users. Usually a radio path in license-free frequency bands is used for this purpose for the high-frequency transmission from and to the motor vehicle. For access to the vehicle and starting the engine this is the so-called PASE system for example. PASE is an abbreviation for PAssive Start and Entry and describes a keyless access and start system, PASE systems have now become the standard solution not only for conveniently locking and unlocking a motor vehicle but also for other driver convenience functions, which in addition to locking and unlocking the doors and the trunk of the vehicle, are also used for activating and deactivating the vehicle immobilizer.

With this keyless vehicle access system the driver only has to carry an identification generator (mobile transmitting and receiving unit) with him, quasi-stationary transmit antennas arranged in or on the vehicle, according to the presence of mobile transmitting and receiving units, return as a reaction to a transmit signal an immediate response signal to the quasi-stationary transmitting and receiving unit when the user is located in one of the effective areas of the transmit antennas of the quasi-stationary transmitting and receiving unit. If the user leaves the effective areas no response signal of the mobile transmitting and receiving unit will be received any longer by the mobile transmitting and receiving unit and as a reaction to this for example automatic locking of the vehicle doors of the motor vehicle is triggered. Transmit signals are transmitted in such cases using corresponding transmit antennas, usually in the 100 kHz range (such as 125 kHz for example). The corresponding response signals from the mobile transmitting and receiving unit are received via a receive antenna in the MHz range for example (such as 433 MHz).

According to the prior art, quasi-stationary transmitting and receiving units are usually connected in such cases to a microcontroller which has the task of controlling the sending out of transmit signals. The disadvantage of this is the current consumed by quasi-stationary transmitting and receiving units and microcontrollers when energy is supplied to the apparatus over longer periods exclusively by the battery of a motor vehicle. This is the case for example if the vehicle is parked for a longer period of time and the apparatus continues to search for a mobile transmitting and receiving unit.

Usually a microcontroller controls a transmitting and receiving unit cyclically at predetermined intervals in order to repeatedly trigger a sending out of transmit signals by the quasi-stationary transmitting and receiving unit. The quasi-stationary transmitting and receiving unit listens after sending out a transmit signal in each case for an answer signal of a mobile transmitting and receiving unit. Such an operating state is frequently also referred to in such cases as polling mode.

In such cases the microcontroller usually operates in two different operating states in order to maintain the polling mode permanently. In a first case the microcontroller is continuously active but is however operated optionally in a first current-reduced mode in order to save energy during operation of the apparatus. In a second case the microcontroller is “woken up” cyclically from an idle mode by internal or external clock generators for controlling the quasi-stationary transmitting and receiving unit. Here too the objective is to save energy during operation of the apparatus compared to a state in which a microcontroller is continuously active.

However the energy requirement or the current consumption of this microcontroller respectively has a disadvantageous effect on the overall current consumption of the apparatus. In addition it is also desirable, in relation to the transmitting and receiving unit, to reduce its current consumption in polling mode.

### SUMMARY

According to various embodiments, an apparatus and a method for access control for a vehicle can be specified in which the current consumption is significantly reduced in polling mode.

According to an embodiment, an apparatus for reducing the current consumption of a control circuit, may comprise: a microcontroller and a transmitting and receiving unit electrically connected to the microcontroller with at least one transmit antenna for wireless transmission of signals, wherein the microcontroller is embodied, in an active operating state, to transfer electrically to the transmitting and receiving unit control signals for its control or configuration data for its operation, wherein the microcontroller is embodied to put the transmitting and receiving unit into a second operating state as a reaction to a specific event by one-off transmission of corresponding configuration data, wherein the microcontroller is embodied to switch immediately into a current-saving or zero-current inactive operating state after it has put the transmitting and receiving unit into the second operating state, wherein the microcontroller is embodied to switch from the inactive operating state into the active operating state as a reaction to a state transition signal of the transmitting and receiving unit, and wherein the transmitting and receiving unit is embodied to receive and to process electrically transferred control signals or configuration data of the microcontroller, wherein the transmitting and receiving unit is embodied to send out transmit signals via the transmit antenna in a first operating state under the control of the control signals of the microcontroller, wherein the transmitting and receiving unit is embodied, in the second operating state, without further subsequent control signals or configuration data of the microcontroller, to send out transmit signals via the transmit antenna independently repeatedly or triggered by the microcontroller at fixed predetermined intervals, and wherein the transmitting and receiving unit is embodied, as a reaction to a second event determined, to switch into the first operating state and to create the state change signal for the microcontroller.

According to a further embodiment, the apparatus may further comprise an antenna activation unit with at least two outputs for activation of transmit antennas, at least two antenna resonant circuits each connected to a separate signal output of the antenna activation unit and simultaneously connected to at least one transmit antenna of different quality and different current consumption, wherein the transmitting and receiving unit is embodied to optionally send transmit signals via one of the at least two outputs of the antenna activation unit. According to a further embodiment, the transmitting and receiving unit may be embodied to select an output of the antenna activation unit with an antenna resonant circuit having a low current consumption or the output of the antenna activation unit with the antenna resonant circuit having the lowest current consumption if the transmitting and receiving unit is in the second operating state. According to a further embodiment, the transmitting and receiving unit may be embodied to switch the outputs of the antenna activation unit for sending out the transmit signals between at least two operating modes of the antenna activation unit with different modulation types for the send signals which have different current consumption. According to a further embodiment, the transmitting and receiving unit may be embodied to select a modulation type with a low current consumption or the modulation type with the lowest current consumption if the transmitting and receiving unit is in the second operating state. According to a further embodiment, the modulation type in the first operating state can be a PSK modulation and the modulation type in the second operating state is an ASK modulation. According to a further embodiment, the first event determined is can be the locking of the doors of the vehicle. According to a further embodiment, the predetermined intervals for independent repeated sending out of the transmit signals in the second operating state of the transmitting and receiving unit may lie in the range between 100 ms and 2000 ms. According to a further embodiment, the second event determined can be the receipt of an answer signal of a mobile transmitting and receiving unit which sends out this signal as a reaction to receiving the transmit signals.

According to another embodiment, a method for reducing the current consumption of a control circuit in which at least one transmitting and receiving unit connected electrically to a microcontroller, sends signals wirelessly via at least one transmit antenna, may comprise the following steps: Transfer by the microcontroller, in an active operating state of the latter, of control signals to the transmitting and receiving unit for its control or of configuration data for its operation, Receipt and processing of the transferred control signals or configuration data by the transmitting and receiving unit, Sending out, under the control of the control signals of the microcontroller, of transmit signals via the transmit antennas by the transmitting and receiving unit in a first operating state, Putting the transmitting and receiving unit into a second operating state by one-off transmission of corresponding configuration data by the microcontroller as a reaction to a first specific event, In the second operating state, independent repeated sending out of transmit signals at fixed predetermined intervals via the transmit antennas by the transmitting and receiving unit without further subsequent control signals or configuration data of the microcontroller or triggered by the microcontroller, Immediate switching of the microcontroller into a current-saving or zero-current inactive operating state after the latter has put the transmitting and receiving unit into the second operating state, Switching the transmitting and receiving unit, as a reaction to a second specific event, into the first operating state and generation of a state change signal for the microcontroller by the latter, and Switching the microcontroller from the inactive operating state into the active operating state as a reaction to the state change signal of the transmitting and receiving unit.

According to a further embodiment of the method, the transmitting and receiving unit optionally may send out transmit signals via one of the outputs of an antenna activation unit which are simultaneously connected via antenna resonant circuits of different respective qualities and different current consumptions to at least one transmit antenna, with the method comprising the following steps: Selection by the transmitting and receiving unit of the output of the antenna activation unit with the antenna resonant circuit having the lowest current consumption, if said unit is in the second operating state. According to a further embodiment of the method, the transmitting and receiving unit may switch the outputs of the antenna activation unit for sending out the transmit signals between at least two operating modes with different modulation types for the transmit signals which have different current consumption, with the method comprising the following steps: Selection of the modulation type with the lowest current consumption by the transmitting and receiving unit when the latter is in the second operating state.

### BRIEF DESCRIPTION OF THE DRAWINGS

The invention will be explained in greater detail below with reference to exemplary embodiments shown in the figures of the drawings, with the same elements having the same reference signs. The figures show:

FIG. 1 a block diagram of a form of embodiment of a quasi-stationary transmitting and receiving unit with a microcontroller connected electrically to the unit;

FIG. 2 a block diagram of the quasi-stationary transmitting and receiving unit with antenna outputs having antenna resonant circuits of different qualities;

FIG. 3 a diagram of the modulation of the transmit signal in a first and a second operating state of the quasi-stationary transceiver unit;

FIG. 4 a flowchart of the method for reducing the current consumption of a control circuit, and

FIG. 5 a flowchart of optional method steps of the method in accordance with FIG. 4.

### DETAILED DESCRIPTION

According to various embodiments, a transmitting and receiving unit may be arranged in or on the vehicle which is connected electrically to a microcontroller. The microcontroller is embodied to transfer control signals or configuration data electrically to the transmitting and receiving unit in order to control the operation of the transmitting and receiving unit in this way. The transmitting and receiving unit is embodied in this case in a first operating mode, under the control of the control signals of the microcontroller, to send out transmit signals via the transmit antennas.

The microcontroller is further embodied to put the transmitting and receiving unit into a second operating state as a reaction to a specific event by one-off transmission of corresponding configuration data. The transmitting and receiving unit is embodied, in this second operating state, without further subsequent control signals or configuration data of the microcontroller, to independently send out transmit signals repeatedly at fixed predetermined intervals via the transmit antennas. The microcontroller is further embodied to switch immediately into a current-saving or zero-current state after it has put the transmitting and receiving unit into the second operating state.

The transmitting and receiving unit is further embodied, in the second operating state, to switch over to current-saving modulation types for the transmit signals and/or to antenna resonant circuits with lower current consumption.

The object is also especially achieved by a method for reducing the current consumption of a control circuit, in which at least one transmitting and receiving unit connected electrically to a microcontroller transmits signals wirelessly via at least one transmit antenna, with the method comprising the following steps: Transfer by the microcontroller, in an active operating state of the controller, of control signals to the transmitting and receiving unit for its control or of configuration data for its operation, receipt and processing of the transferred control signals or configuration data by the transmitting and receiving unit, sending out under the control of the control signals of the microcontroller transmit signals via the transmitter antennas by the transmitting and receiving unit in a first operating state, putting the transmitting and receiving unit into a second operating state by one-off transmission of corresponding configuration data by the microcontroller as a reaction to a first event determined, in the second operating state automatic repeated sending out of transmit signals at fixed predetermined intervals by the transmit antennas by the transmitting and receiving unit without further subsequent control signals or configuration data of the microcontroller, immediate switching of the microcontroller into a current-saving or zero-current inactive operating state after the latter has put the transmitting and receiving unit into the second operating state, switching the transmitting and receiving unit, as a reaction to a second determined event, into the first operating state and creation of a state change signal for the microcontroller by the latter and switching of the microcontroller from the inactive operating state into the active operating state as a reaction to the state change signal of the transmitting and receiving unit.

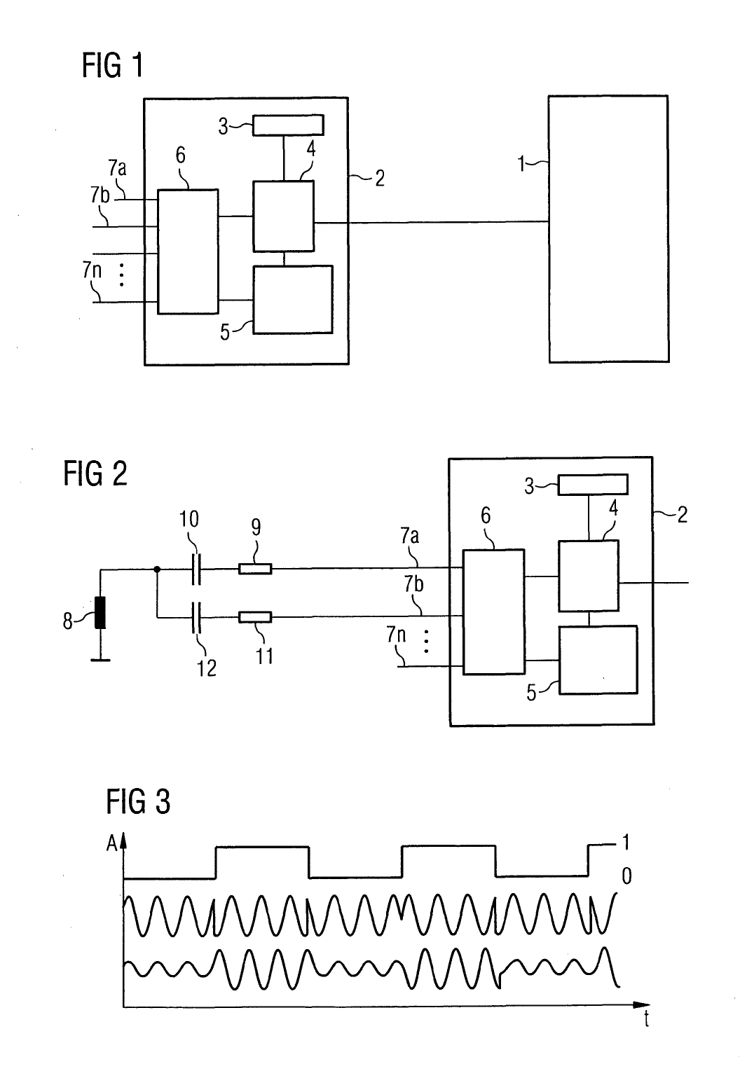

FIG. 1 shows a block diagram of a form of embodiment of an apparatus for reducing the current consumption of a control circuit, which shows a microcontroller 1 (or similar control devices or microprocessors) and a transmitting and receiving unit 2. In accordance with FIG. 1, the transmitting and receiving unit 2 comprises a timer 3, a control unit 4, a current monitoring unit 5 and an antenna activation unit 6 with a plurality of antenna outputs 7a, 7b . . . 7n for activation of transmit antennas. The transmit antennas themselves are not explicitly shown in FIG. 1.

The timer 3 is connected to the control unit 4, which in its turn is connected to the current monitoring unit 5 and the antenna activation unit 6. The current monitoring unit 5 is likewise connected to the antenna activation unit 6. Furthermore, in accordance with FIG. 1, the microcontroller 1 is connected to the transmitting and receiving unit 2, with this connection being implemented between the microcontroller 1 and the control unit 4.

The apparatus has two different operating states of the transmitting and receiving unit 2. In the first operating state the microcontroller 1, each time a transmit signal is to be sent out by the transmitting and receiving unit 2, transmits corresponding control signals to the transmitting and receiving unit 2 or to its internal control unit 4 respectively. The control unit 4 then causes the antenna activation unit 6 to make available transmit signals with the corresponding modulation type at the antenna outputs 7a, 7b . . . 7n.

These transmit signals are emitted via transmit antennas not shown in FIG. 1. In such cases all features that are necessary for the respective transmit signal and its output are defined by the control signals of the microcontroller 1. These can have features such as for example the amplitude of the transmit signal, the information to be transmitted, the type of modulation of the transmit signal and at which of the outputs 7a, 7b . . . 7n of the antenna control unit 6 the transmit signals are to be provided. The sending out of such transmit signals is typically used in a keyless access system for a vehicle to establish the presence of a mobile transmitting and receiving unit in the effective area of the transmit antennas. In such cases a mobile transmitting and receiving unit can receive such a transmit signal when it is located in the effective area of a transmit antenna and usually responds to said signal immediately with a corresponding answer signal.

Since establishing the presence of a mobile transmitting and receiving unit within the effective range of the transmitter antennas of a vehicle is usually to be a continuous process, the same transmit signals are sent out via the transmit antennas of the access system (for example the PASE system) repeated continuously at predetermined intervals and the quasi-stationary transmitting and receiving unit continuously listens for incoming answer signals of a mobile transmitting and receiving unit. In accordance with the prior art the transmit signals in such cases are usually sent out at fixed predetermined intervals of 500 ms for example.

This operation of a control circuit in which the same transmit signals are sent out continuously over a longer period of time is frequently also referred to as polling mode. Only when an answer signal of a mobile transmitting and receiving unit is received might this polling mode be interrupted or aborted in order to initiate further subsequent actions or to send transmit signals with other features (transmitted information, transmit antennas used, signal amplitude, modulation type etc.). Such an action following the first answer signal received from a mobile transmitting and receiving unit can for example be the unlocking of the vehicle doors if the answer signal is received from a mobile transmitting and receiving unit authorized for accessing the vehicle.

Such polling operation is likewise typically activated in such cases as a reaction to the occurrence of a specific event. Such an event can for example be that a mobile transmitting and receiving unit belonging to the access system of the vehicle and carried by a user leaves the effective area of the transmit antennas of the access system. As a result of this for example an automatic locking of the vehicle doors can be initiated and the access system switches to the described polling mode in order to determine a subsequent renewed presence of a mobile transmitting and receiving unit. This polling mode is active in this case until such time as no user carrying a mobile transmitting and receiving unit authorized to access the vehicle approaches the vehicle or moves within the effective range of the transmit antennas operated in polling mode.

According to various embodiments, the arrangement in accordance with FIG. 1 for executing this polling mode can be put into a second operating state which advantageously has a lower current consumption compared to the first operating state. Since in polling mode the same transmit signals or transmit signals with fixed predetermined parameters are continuously sent out, in this case a one-off transmission of configuration data is undertaken at the beginning of polling mode by the microcontroller 1 to the quasi-stationary transmitting and receiving unit 2. This configuration data is received by the control unit 4 of the quasi-stationary transmitting and receiving unit 2 and this data switches said unit into the second operating mode for further operation. In such cases, in this second operating mode (polling mode) too, different transmit signals can be sent out by different transmit antennas if this is a sensible option.

In this second operating mode the quasi-stationary transmitting and receiving unit 2 sends signals via the transmit antennas without further subsequent control signals or configuration data of the microcontroller independently repeatedly at predetermined intervals. The transmit signals are sent via the transmit antennas in such cases by the appropriate activation of the antenna control unit 6 by the control unit 4 in conjunction with the timer 3. The configuration data received once at the beginning of polling mode from the microcontroller 1 defines in such cases for example, using the timer 3, the time intervals between transmit signals sent out as well as with appropriate activation of the antenna control unit 6 by the control unit 4, typically the transmit power, modulation type and the respective transmit antennas assigned for the transmit signals. As an alternative to the method of operation described above the transmit process can also be triggered in this second operating mode of the quasi-stationary transmitting and receiving unit 2 by the microcontroller 1.

According to various embodiments, the microcontroller 1 continues to switch immediately from its previously active operating mode into a current-saving or zero-current inactive operating mode after it has placed the quasi-stationary transmitting and receiving unit 2 into the second operating state. Should the microcontroller (1), as described above, also continue to trigger the sending of the transmit signals via the transmit antennas in this current-saving or zero-current inactive operating mode, it can be “woken up” for example cyclically for short periods of time from this current-saving or zero-current inactive operating mode. This current-saving or zero-current inactive operating mode of microcontroller 1 is maintained in these cases until such time as polling mode (here the second operating mode of the quasi-stationary transmitting and receiving unit 2) is aborted because of a second specific event. Such an event can for example be establishing once again the presence of a mobile transmitting and receiving unit in the effective area of the transmit antennas of the keyless entry system.

In such a case the quasi-stationary transmit and receive unit 2 switches immediately from the second operating state back into the first operating state and generates a state change signal which causes the microcontroller 1 to switch back from the current-saving or zero-current inactive operating mode into the active operating mode. Subsequently the microcontroller 1 can resume control over the transmit signals to be sent by directing the corresponding control signals again to the quasi-stationary transmit and receive unit 2 which is now once again in the first operating state.

The current-saving or even zero-current inactive operating mode of the microcontroller 1 used in polling mode thus makes a significant reduction in current consumption possible compared to the prior art. A keyless access system of a vehicle, once it has been locked, can under some circumstances remain in the described polling mode for many hours or even several days (longer-term parking) so that a reduction in the energy consumption over such longer periods is especially noticeable.

FIG. 2 shows a block diagram of an arrangement of the transmitting and receiving unit according to various embodiments, with antenna outputs with antenna synchronization circuits of different qualities and different current consumption. FIG. 2 again includes the transmitting and receiving unit 2 known from FIG. 1 with timer 3, control unit 4, current monitoring unit 5, antenna activation unit 6 and a plurality of antenna outputs 7a, 7b . . . 7n for activation of transmit antennas. Furthermore FIG. 2 comprises an antenna 8 shown here as an inductor as well as two resistors 9 and 11 and two capacitors 10 and 12.

In accordance with FIG. 2, the transmit antenna 8 is connected via a series circuit consisting of the resistor 9 and the capacitor 10 to the output 7a of the antenna activation unit 6 of the transmitting and receiving unit 2. Furthermore the transmit antenna 8 is connected via a series circuit consisting of the resistor 11 and the capacitor 12 likewise to the output 7b of the antenna activation units 6 of the transmit and receive unit 2. In further forms of embodiment a transmit antenna can also be connected in such cases to more than two outputs 7a, 7b . . . 7n of the antenna activation unit 6 via corresponding series circuits consisting of resistors and capacitors of different values.

In the manner illustrated in FIG. 2, a first resonant circuit is embodied at output 7a of the antenna activation unit 6 from the inductor of the antenna 8, the resistor 9 and the capacitor 10. A second resonant circuit is embodied at output 7b of the antenna activation unit 6 from the inductor of the antenna 8, the resistor 11 and the capacitor 12. In this case the values of the resistors 9 and 11 and the capacitors 10 and 12 are selected so that the first resonant circuit and the second resonant circuit differ in respect of their quality and thus also have a different current consumption with the same transmit signal at output 7a or 7b.

The transmit signal in such cases is optionally applied to output 7a or output 7b, meaning that, at any given time, only one output of a number of outputs connected to an antenna has a transmit signal applied to it. In a further form of embodiment an antenna can also be connected in such cases to more than two outputs of the antenna activation unit 6 via series circuits comprising resistors and capacitors of different values. In order to further reduce the current consumption of the apparatus in the second operating state (polling mode) compared to the first operating state as desired, according to various embodiments, a signal output 7a, 7b . . . 7n of the antenna activation unit 6 is selected for transmitting the transmit signals which has an antenna resonant circuit with a lower current consumption or the antenna resonant circuit with the lowest current consumption.

This choice can in such cases for example depend on the range to be achieved with the transmit signal sent out or which bandwidth is to be available for the transmit signal respectively. In such cases it can be established with the aid of the current monitoring unit 5 which is the positive choice or the most positive choice in respect of low power consumption. Thus for example, by selecting a signal path with high quality of the resonant circuit in the second operating mode of the transmitting and receiving unit 2, the range can initially be increased for the transmit signal. At the same time, while retaining the same range as in the first operating state of the transmitting and receiving unit 2, the transmit power of the transmit signals and thereby the current consumption of the transmitting and receiving unit 2 can be reduced.

A further option for reducing the current consumption of the apparatus in accordance with FIG. 1 consists, in accordance with various embodiments, of changing the modulation type for a transmit signal in relation to the first operating state of the transmitting and receiving unit in its second operating state. This can have an advantageous effect since different types of modulation have a different current consumption and an appropriately current-saving modulation type can be selected in the second operating state (polling mode) of the transmitting and receiving unit. PSK modulation (PSK: Phase Shift Keying) and ASK modulation (ASK: Amplitude Shift Keying) are regarded here as examples of such different types of modulation. Both types of modulation are modulation methods frequently used for wireless transmission of signals. In such cases, in the first operating state of the transmitting and receiving unit 2 in accordance with FIG. 1, PSK modulation of the transmit signals is typically used.

In PSK modulation a digital data stream consisting of the values “0” and “1” is converted into a sine-wave carrier signal of which the phase position differs for the different digital data. In the case of a binary data signal with the values “0” and “1”, the phase position of the PSK-modulated signal components typically differs by 180°. The signal amplitude of the carrier signal is the same for all phase positions in PSK modulation. A simple example of PSK modulation and ASK modulation can be found in FIG. 3.

FIG. 3 shows the timing of the amplitude A (ordinate) of signals plotted against time t (abscissa). The signal shown at the top in FIG. 3 shows a simplified digital data stream with ongoing switching between data values “0” and “1”. Shown in the center of FIG. 3 is the timing curve of an associated PSK-modulated signal which is produced by the data stream shown at the top in FIG. 3. This reveals a phase position of the signal for a data value “1” offset by 180° in relation to a data value “0” for the same carrier signal amplitude.

Furthermore the signal curve of an ASK-modulated signal is shown at the bottom of FIG. 3. In ASK modulation a carrier signal which is again a sine-wave signal is modulated in the digital data stream in its amplitude in accordance with data values “0” and “1”. It can be seen from FIG. 3 that the amplitude of the transmit signal is embodied smaller in this case for data values “0” than for data values “1” (cf. top signal curve with bottom signal curve in accordance with FIG. 3). This means that an ASK-modulated transmit signal for the same digital input data stream and the same maximum amplitude of the carrier signal on average has a smaller transmit power than a PSK-modulated transmit signal. The current consumption is thus reduced for an ASK-modulated transmit signal compared to a PSK-modulated transmit signal.

According to various embodiments, in the second operating state of the transmitting and receiving unit 2, in accordance with FIGS. 1 and 2 for example, such an ASK modulation is used for the transmit signals in order to achieve the desired reduction of the current consumption compared to using PSK modulation in the first operating state of the transmitting and receiving unit 2. If the transmitting and receiving unit 2 switches into the first operating state again, the apparatus in accordance with FIGS. 1 and 2 returns to PSK modulation. The comparison between PSK and ASK is only used for illustrative purposes here. In the second operating mode of the transmitting and receiving unit 2 other modulation types can also be advantageously employed which lead to a reduction of current consumption by comparison with the first operating state.

The specified measures for reducing the current consumption in the second operating state of the transmitting and receiving unit, which relate to the microcontroller 1, the resonant circuit quality of the signal path to the transmit antenna and also to the modulation type, are independent of one another and can optionally be employed individually per se or in any given combination.

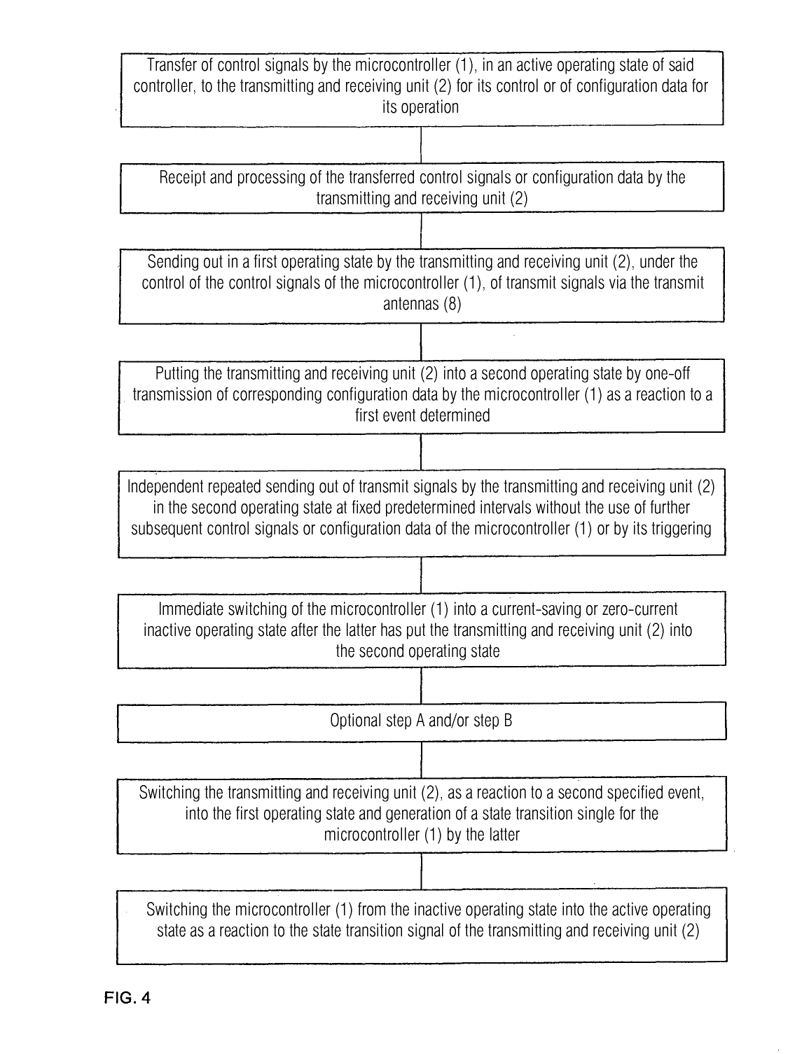

FIG. 4 shows a flow diagram of the typical form of embodiment of the method steps for reducing the current consumption of a control circuit. The method shown in FIG. 4 relates in this case to the typical form of embodiment shown in FIG. 1. In accordance with FIG. 4, a first method step involves the transfer of control signals by the microcontroller 1 in an active operating state from said controller to the transmitting and receiving unit 2 for its control or of configuration data for its operation. A second method step involves the receiving and processing of the transferred control signals or configuration data by the transmitting and receiving unit 2. A third method step involves the sending out, under the control of the control signals of the microcontroller 1, of transmit signals via the transmit antennas 8 by the transmitting and receiving unit 2 in a first operating state of said unit. A fourth method step involves putting the transmitting and receiving unit 2 into a second operating state through one-off transmission of appropriate configuration data by the microcontroller 1 as a reaction to a first specific event. A fifth method step involves the automatic repeated sending out of transmit signals by the transmitting and receiving unit 2 in the second operating state at fixed predetermined intervals, without using further subsequent control signals or configuration data of the microcontroller 1.

A sixth method step involves immediately switching the microcontroller 1 into a current-saving or zero-current inactive operating state, after the latter has put the transmitting and receiving unit 2 in the second operating state. A seventh method step optionally involves the additional method step A or B or both method steps A and B. If neither of the two optional method steps A and/or B is desired, the method in accordance with FIG. 4 continues after the sixth method step with the eighth method step.

An eighth method step involves, as a reaction to a second event determined, the switching of the transmitting and receiving unit 2 into the first operating state and the generation of a state change signal for the microcontroller 1 by the transmitting and receiving unit 2. A ninth method step involves, as a reaction to the state change signal of the transmitting and receiving unit 2, the switching of the microcontroller 1 from the inactive operating state into the active operating state.

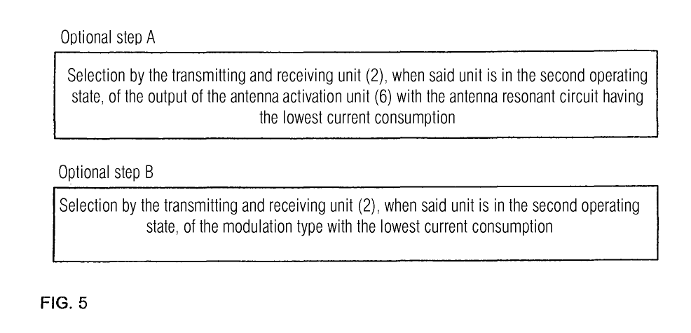

Optionally the method in accordance with FIG. 4 can additionally comprise one or both of the method steps A and/or B subsequently executed shown in FIG. 5:

In accordance with FIG. 5 the optional method step A involves the selection of the output of the antenna activation unit (6) with the antenna resonant circuit having the lowest current consumption by the transmitting and receiving unit (2) if the latter is in the second operating state (see FIG. 2).

In accordance with FIG. 5 the optional method step B involves the selection of the modulation type for the transmit signals with the lowest current consumption by the transmitting and receiving unit (2), if the latter is in the second operating state (see FIG. 3).

### LIST OF REFERENCE SIGNS

1 Microcontroller
2 Transmitting and receiving unit
3 Timer
4 Control unit
5 Current monitoring unit
6 Antenna activation unit
7a-n Outputs of the antenna activation unit
8 Transmit antenna
9 Resistor
10 Capacitor
11 Resistor
12 Capacitor

What is claimed is:

1. An apparatus for reducing the current consumption of a control circuit, comprising:
a microcontroller and a transmitting and receiving unit electrically connected to the microcontroller with at least one transmit antenna for wireless transmission of signals, wherein the microcontroller is operable:
in an active operating state, to transfer electrically to the transmitting and receiving unit control signals for its control or configuration data for its operation,
to put the transmitting and receiving unit into a second operating state as a reaction to a specific event by one-off transmission of corresponding configuration data,
to switch immediately into a current-saving or zero-current inactive operating state after it has put the transmitting and receiving unit into the second operating state, and
to switch from the inactive operating state into the active operating state as a reaction to a state transition signal of the transmitting and receiving unit, and wherein the transmitting and receiving unit is operable:
to receive and to process electrically transferred control signals or configuration data of the microcontroller,
to send out transmit signals via the transmit antenna in a first operating state under the control of the control signals of the microcontroller,
in the second operating state, without further subsequent control signals or configuration data of the microcontroller, to send out transmit signals via the transmit antenna independently repeatedly or triggered by the microcontroller at fixed predetermined intervals, and
as a reaction to a second event determined, to switch into the first operating state and to create the state change signal for the microcontroller.

2. The apparatus according to claim 1, comprising
an antenna activation unit with at least two outputs for activation of transmit antennas,
at least two antenna resonant circuits each connected to a separate signal output of the antenna activation unit and simultaneously connected to at least one transmit antenna of different quality and different current consumption,
wherein the transmitting and receiving unit is operable to optionally send transmit signals via one of the at least two outputs of the antenna activation unit.

3. The apparatus according to claim 2, wherein the transmitting and receiving unit is operable to select an output of the antenna activation unit with an antenna resonant circuit having a low current consumption or the output of the antenna activation unit with the antenna resonant circuit having the lowest current consumption if the transmitting and receiving unit is in the second operating state.

4. The apparatus according to claim 1, wherein the transmitting and receiving unit is embodied to switch the outputs of the antenna activation unit for sending out the transmit signals between at least two operating modes of the antenna activation unit with different modulation types for the send signals which have different current consumption.

5. The apparatus according to claim 4, wherein the transmitting and receiving unit is embodied to select a modulation type with a low current consumption or the modulation type with the lowest current consumption if the transmitting and receiving unit is in the second operating state.

6. The apparatus according to claim 4, wherein the modulation type in the first operating state is a PSK modulation and the modulation type in the second operating state is an ASK modulation.

7. The apparatus according to claim 1, wherein the first event determined is the locking of the doors of the vehicle.

8. The apparatus according to claim 1, wherein the predetermined intervals for independent repeated sending out of the transmit signals in the second operating state of the transmitting and receiving unit lie in the range between 100 ms and 2000 ms.

9. The apparatus according to claim 1, wherein the second event determined is the receipt of an answer signal of a mobile transmitting and receiving unit which sends out this signal as a reaction to receiving the transmit signals.

10. A method for reducing the current consumption of a control circuit in which at least one transmitting and receiving unit connected electrically to a microcontroller, sends signals wirelessly via at least one transmit antenna, with the method comprising:
transferring by the microcontroller, in an active operating state of the latter, control signals to the transmitting and receiving unit for its control or of configuration data for its operation,
receiving and processing of the transferred control signals or configuration data by the transmitting and receiving unit,
sending out, under the control of the control signals of the microcontroller, transmit signals via the transmit antennas by the transmitting and receiving unit in a first operating state,
putting the transmitting and receiving unit into a second operating state by one-off transmission of corresponding configuration data by the microcontroller as a reaction to a first specific event,
in the second operating state, independent repeated sending out of transmit signals at fixed predetermined intervals via the transmit antennas by the transmitting and receiving unit without further subsequent control signals or configuration data of the microcontroller or triggered by the microcontroller,
immediate switching of the microcontroller into a current-saving or zero-current inactive operating state after the latter has put the transmitting and receiving unit into the second operating state,
switching the transmitting and receiving unit, as a reaction to a second specific event, into the first operating state and generation of a state change signal for the microcontroller by the latter, and
switching the microcontroller from the inactive operating state into the active operating state as a reaction to the state change'signal of the transmitting and receiving unit.

11. The method according to claim 10, wherein the transmitting and receiving unit optionally sends out transmit signals via one of the outputs of an antenna activation unit which are simultaneously connected via antenna resonant circuits of different respective qualities and different current consumptions to at least one transmit antenna, with the method comprising:
selecting by the transmitting and receiving unit the output of the antenna activation unit with the antenna resonant circuit having the lowest current consumption, if said unit is in the second operating state.

12. The method according to claim 10, wherein the transmitting and receiving unit switches the outputs of the antenna activation unit for sending out the transmit signals between at least two operating modes with different modulation types for the transmit signals which have different current consumption, with the method comprising:
selecting the modulation type with the lowest current consumption by the transmitting and receiving unit when the latter is in the second operating state.

13. An method for reducing the current consumption of a control circuit in a system comprising a microcontroller and a wireless transmitting and receiving unit, comprising:
performing the following steps by the microcontroller:
in an active operating state, transferring electrically to the transmitting and receiving unit control signals for its control or configuration data for its operation,
putting the transmitting and receiving unit into a second operating state as a reaction to a specific event by one-off transmission of corresponding configuration data,
switching the microcontorller immediately into a current-saving or zero-current inactive operating state after it has put the transmitting and receiving unit into the second operating state, and
switching the microcontroller from the inactive operating state into the active operating state as a reaction to a state transition signal of the transmitting and receiving unit,
and performing the following steps by the transmitting and receiving unit:
receiving and processing electrically transferred control signals or configuration data of the microcontroller,
sending out transmit signals via the transmit antenna in a first operating state under the control of the control signals of the microcontroller,
in the second operating state, without further subsequent control signals or configuration data of the microcontroller, sending out transmit signals via the transmit antenna independently repeatedly or triggered by the microcontroller at fixed predetermined intervals, and
as a reaction to a second event determined, switching into the first operating state and creating the state change signal for the microcontroller.

14. The method according to claim 13, wherein the system comprises an antenna activation unit with at least two outputs for activation of transmit antennas, at least two antenna resonant circuits each connected to a separate signal output of the antenna activation unit and simultaneously connected to at least one transmit antenna of different quality and different current consumption, wherein the method comprises:
sending by the transmitting and receiving unit optionally transmit signals via one of the at least two outputs of the antenna activation unit.

15. The method according to claim 14, further comprising selecting by the transmitting and receiving unit an output of the antenna activation unit with an antenna resonant circuit having a low current consumption or the output of the antenna activation unit with the antenna resonant circuit having the lowest current consumption if the transmitting and receiving unit is in the second operating state.

16. The method according to claim 13, further comprising switching by the transmitting and receiving unit the outputs of the antenna activation unit for sending out the transmit signals between at least two operating modes of the antenna activation unit with different modulation types for the send signals which have different current consumption.

17. The method according to claim 16, further comprising selecting by the transmitting and receiving unit a modulation type with a low current consumption or the modulation type with the lowest current consumption if the transmitting and receiving unit is in the second operating state.

18. The method according to claim 16, wherein the modulation type in the first operating state is a PSK modulation and the modulation type in the second operating state is an ASK modulation.

19. The method according to claim 13, wherein the first event determined is the locking of the doors of the vehicle and the second event determined is the receipt of an answer signal of a mobile transmitting and receiving unit which sends out this signal as a reaction to receiving the transmit signals.

20. The method according to claim 13, wherein the predetermined intervals for independent repeated sending out of the transmit signals in the second operating state of the transmitting and receiving unit lie in the range between 100 ms and 2000 ms.
